(19) United States
(12) Patent Application Publication
(10) Pub. No.: US 2020/0009479 A1
(43) Pub. Date: Jan. 9, 2020

(54) DE-SANDING A DIGESTER

(71) Applicant: U.S. Submergent Technologies, LLC, Sarasota, FL (US)

(72) Inventor: Denver Stutler, JR., Sarasota, FL (US)

(21) Appl. No.: 16/502,195

(22) Filed: Jul. 3, 2019

Related U.S. Application Data
(60) Provisional application No. 62/693,595, filed on Jul. 3, 2018.

(51) Int. Cl. B01D 21/02

(52) U.S. Cl. CPC B01D 21/02; B01D 21/245

(57) ABSTRACT

Provided is a method and system for separating components of a solid and liquid mixture. In an embodiment, the method includes de-sanding a treatment system. Digesters, clarifiers, wastewater apparatuses, self-contained processing tanks, process tanks, and the like, accumulate sand and other undesired inorganic components that ultimately prevent filtering, cleaning, and processing of the solid and liquid mixtures therein. The mixture in the treatment system may initially include sand, water, and biosolids. The mixture may be routed into a pressurized tank to separate the inorganic solids and liquid components based on their density and buoyancy. A de-sanded mixture may then proceed through the remaining cleaning process.

### RELATED APPLICATION DATA

This application claims priority to and is a non-provisional of U.S. Provisional Patent Application No. 62/693,595 filed Jul. 3, 2018 entitled “De-Sanding a Digester,” the disclosures of which is hereby incorporated herein by reference in its entirety.

### FIELD OF THE INVENTION

The present disclosure relates generally to methods and processes for separating components of a solid and liquid mixture or slurry. In an embodiment, the present disclosure relates generally to removing solids from a wastewater treatment system.

### BACKGROUND

Wastewater treatment systems such as digesters, clarifiers, wastewater apparatuses, process tanks, and the like must be cleaned periodically in order to maintain proper fluid flow and capacity. Cleaning wastewater treatment systems may remove sand and other deleterious materials that have infiltrated into, for example, a digester or a self-contained processing tank. Additionally, cleaning wastewater treatment systems may remove solid materials that have settled out from the normally slow moving waste slurry that varies in volume and flow rate depending on the collective amount of effluents emptied into the wastewater treatment system over time. Sand and other deleterious materials may inhibit the further cleaning and separation of the remaining components in a wastewater treatment system, such as biosolids (where the biosolids are one or more of sewage, sludge, animal waste, etc.), and water. For example, the sand may act as a bridge and clog a belt filter press or otherwise prevent the appropriate operation of the belt filter press utilized to further clean the contents of the wastewater treatment system.

In order to properly clean large capacity wastewater treatment systems such as processing tanks, self-contained processing tanks or the like, an efficient and cost effective method of cleaning must be employed that first removes the sand and other clogging components from the mixture, before and in addition to subsequent filtering and processing of the resulting mixtures.

### SUMMARY

The following presents a summary of this disclosure to provide a basic understanding of some aspects. This summary is not intended to identify key or critical elements or define any limitations of embodiments or claims. Furthermore, this summary may provide a simplified overview of some aspects that may be described in greater detail in other portions of this disclosure.

Disclosed is a method of separating solid and liquid and removing certain solid components in a mixture (typically leaving the smaller solid and removing the larger solids). In an example, the method comprises removing sand, grit or other solids having a similar or greater density from a wastewater treatment system such as by way of a non-limiting example, a digester, clarifier, wastewater apparatus, collection tank, process tank, etc., herein after referred to as a treatment system. The treatment system may house a solid and liquid mixture including water, biosolids (where the biosolids are one or more of sewage, sludge, animal waste, etc.), sand, grit and other deleterious materials. The mixture may be fully mixed, partially mixed, or layered.

A submersible pump is submersed into the mixture in the treatment system and pumps the mixture from the treatment system bottom, or other depths as required, to remove the mixture from the treatment system. The removed mixture is run from the submersible pump into a pressurized debris tank. The pressurized debris tank may be portable. For example, the pressurized debris tank may be located on a vehicle, such as a truck, or may be rolled off a truck and positioned on the ground, or may otherwise be a dedicated tank. The pressurized debris tank may settle the components of the mixture based on their density and/or buoyancy, such that the more dense components settle on the bottom of the pressurized tank, and the more buoyant components rise to the top of the pressurized tank. For example, the sand, having a greater density, will settle on the bottom of the pressurized tank, whereas the biosolids and water, having a higher buoyancy, will not settle on the bottom of the pressurized tank and will instead rise to the top of the pressurized tank, above the sand. Due to the positive pressure inside the pressurized debris tank, the supernatant of the pressurized mixture, comprising the water and/or biosolids, is then transmitted out of the pressurized debris tank, into a debris or decant hose, and back into the original treatment system. As the supernatant is routed back into the treatment system, the mixture in the treatment system is agitated, causing a slurry of all the components inside the treatment system to be mixed together.

In an embodiment, a slurry, wherein all, or some of, the components are mixed together, may be needed for the water to carry the sand and/or grit out of the treatment system and into the pressurized tank. In one example, at least the sand and water need to be mixed together to carry the sand out of the treatment system and into the pressurized tank. The slurry may be partially mixed, fully mixed or separated but removed together. The method of de-sanding may not need a separate water supply and, instead, the water within the treatment system may be utilized to remove the sand and grit. The method may be accomplished with the treatment system being online (i.e., operating) or being offline (i.e., not operating).

In an embodiment, the process of routing a solid and liquid mixture from a treatment system into a submersible pump, may be transmitted via a debris hose to a pressurized tank and back into the treatment system via the positive pressure from the submersible pump and a decant hose, is repeated until all the sand or other dense components are removed from the mixture.

In an embodiment, computations are performed to determine the estimated amount of sand or other components of the same or similar density to be removed from the treatment system. Once the volume of sand or other components to be removed has been determined, a slurry concentration may be estimated to determine the rate of sand or other components removed. Thereafter, the amount of liquid required to move the material may be determined and, finally, the amount of times the solid and liquid mixture of the treatment system will need to be cycled through the de-sanding process to remove the sand or other components may be quantified.

In an embodiment, a supernatant including water and biosolids may be further separated through a dewatering process, such as a belt filter press, filter, and centrifuge.

Accordingly, in one embodiment, the present invention relates to a system for de-sanding a treatment system comprising: at least one liquid, or slurry, holding device, wherein the at least one liquid, or slurry, holding device contains therein at least one mixture of water with at least one type of solid sand material and/or at least one type of biosolids; at least one submersible pump, wherein the submersible pump is able to pump the mixture contained in the at least one liquid, or slurry, holding device; at least one debris tank, operatively connected to the at least one submersible pump and the at least one liquid, or slurry, holding device via at least one hose; and at least one decant hose that is operatively connected to both the at least one debris tank and the at least one at least one liquid, or slurry, holding device, wherein the at least one decant hose is designed to return a portion of the material from the at least one debris tank to the at least one liquid, or slurry, holding device, wherein the system removes at least one of the sand or biosolids located within the mixture of the water with at least one type of solid sand material and/or at least one type of biosolids.

Accordingly, in another embodiment, the present invention relates to a method for de-sanding a treatment system comprising: supplying at least one liquid, or slurry, holding device, wherein the at least one liquid, or slurry, holding device contains therein at least one mixture of water with at least one type of solid sand material and/or at least one type of biosolids; supplying at least one submersible pump, wherein the submersible pump is able to pump the mixture contained in the at least one liquid, or slurry, holding device; supplying at least one debris tank, operatively connected to the at least one submersible pump and the at least one liquid, or slurry, holding device via at least one hose; and supplying at least one decant hose that is operatively connected to both the at least one debris tank and the at least one at least one liquid, or slurry, holding device, wherein the at least one decant hose returns a portion of the material from the at least one debris tank to the at least one liquid, or slurry, holding device, and wherein the system removes at least one of the sand or biosolids located within the mixture of the water with at least one type of solid sand material and/or at least one type of biosolids.

Accordingly, in still another embodiment, the present invention relates to a method for de-sanding a treatment system comprising: supplying at least one liquid, or slurry, holding device, wherein the at least one liquid, or slurry, holding device contains therein at least one mixture of water with at least one type of solid sand material and at least one type of biosolids; supplying at least one submersible pump, wherein the submersible pump is able to pump the mixture contained in the at least one liquid, or slurry, holding device; supplying at least one debris tank, operatively connected to the at least one submersible pump and the at least one liquid, or slurry, holding device via at least one hose; and supplying at least one decant hose that is operatively connected to both the at least one debris tank and the at least one at least one liquid, or slurry, holding device, wherein the at least one decant hose returns a portion of the at least one type of biosolids from the at least one debris tank to the at least one liquid, or slurry, holding device, and wherein the system removes at least one of the sand located within the mixture of the water with at least one type of solid sand material and the at least one type of biosolids.

The following description and the drawings disclose various illustrative aspects. Some improvements and novel aspects may be expressly identified, while others may be apparent from the description and drawings.

### BRIEF DESCRIPTION OF THE DRAWINGS

The present teachings may be better understood by reference to the following detailed description taken in connection with the following illustrations, wherein:

FIG. 1 depicts an apparatus such as a tank containing a solid and liquid mixture to be separated in accordance with aspects disclosed herein;

FIG. 2 depicts the system and method of separation of a solid and liquid mixture in an apparatus in accordance with aspects disclosed herein;

FIG. 3 depicts an tank of the apparatus of FIG. 2 after separation of a solid and liquid mixture in accordance with aspects disclosed herein;

FIG. 4 depicts an example of how inorganic material, such as sand, impacts the dewatering of biosolids via a belt filter press; and

FIG. 5 depicts an exemplary wastewater treatment system.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings. In this disclosure, numerous specific details provide a thorough understanding of the subject disclosure. It should be understood that aspects of this disclosure may be practiced with other embodiments not necessarily including all aspects described herein, etc.

While described methods or processes may be listed in a certain order for clarity of explanation, the methods or processes are not limited by the order unless context suggests otherwise or warrants a particular order. It is further noted that some actions may occur in different orders or concurrently with other actions. Moreover, different actions may be utilized to implement the methods described hereinafter. Various actions may be completed by one or more of users, mechanical machines, automated assembly machines (e.g., including one or more processors or computing devices), etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

While embodiments may refer to a particular example of the described separation process as for use in wastewater treatment system applications wherein sand, grit or other similar material needs to be removed from a slurry or mixture, it is noted that disclosed embodiments may be applicable to various other industries. Generally, described embodiments may be utilized for any application that requires processing of a large mixture of fluids and solids having a different density or buoyancy, such as oil fracking, ocean water clean up, mining, food and beverage processing, and construction. The disclosed separation process may be particularly useful in any system that produces wastewater or waste liquid. The disclosed separation process may be applied in at least any of the following digester, clarifier, wastewater apparatus, collection tank, process tank, and the like. The disclosed separation process is particularly useful in cleaning digesters.

Disclosed is a separation process for separating and removing solid components in a mixture or slurry. In an example, the method comprises removing inorganic material such as sand, grit or other solids having a similar or greater density from a digester, clarifier, wastewater apparatus, collection tank, process tank, etc. Removing the inorganic material may prevent subsequent clogging and bridging of the filters used to separate the remaining biosolids (where the biosolids are one or more of sewage, sludge, animal waste, etc.) and water.

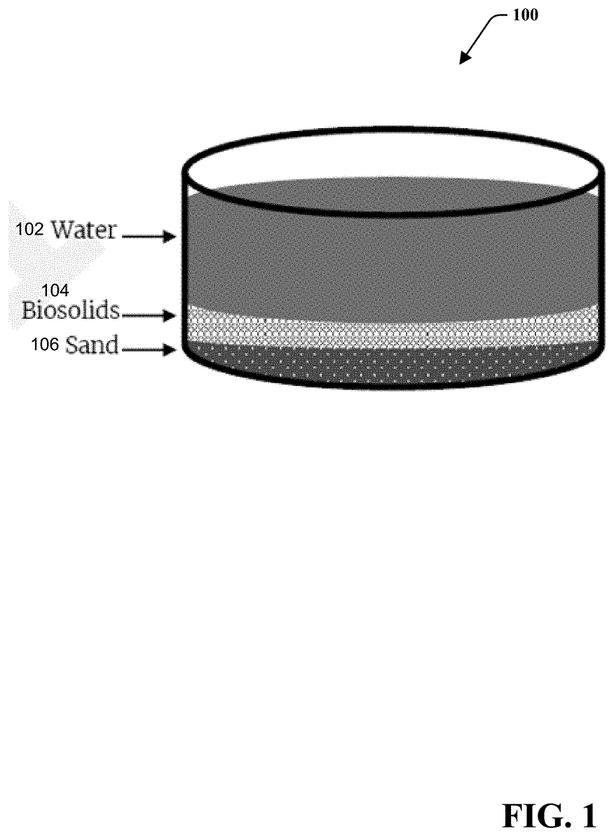

In one embodiment, the apparatus of the present invention comprises a wastewater treatment system and/or tank 100 of FIG. 1 that may be operatively connected to one or more of one or more sewers, one or more sumps, one or more wet wells, one or more digesters, one or more clarifiers, one or more classifiers, one or more wastewater apparatuses, one or more collection tanks, one or more process tanks, and the like, that generally comprise a mixture of liquids and solid components. In one embodiment, a treatment system such as tank 100 of FIG. 1 may house a solid and liquid mixture or slurry including water 102, biosolids 104, sand 106, and other deleterious materials (not pictured). It is noted that the treatment system, or other apparatus, may include more solid and/or liquid components. However, if the treatment system contains more water the present teachings may be more efficient and effective—the material should be wet enough to run through the submersible pump as described below. The mixture may be fully mixed, partially mixed, or layered as shown in FIG. 1.

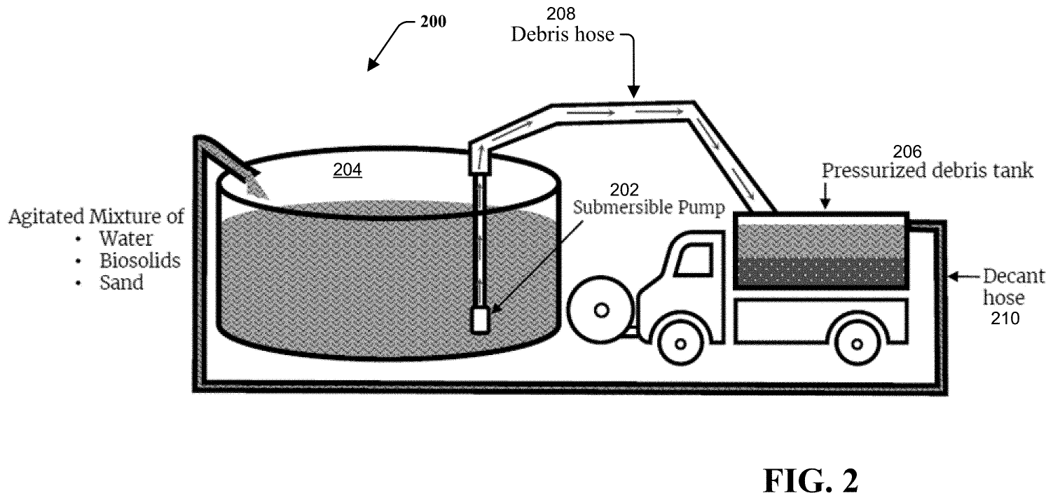

FIG. 2 depicts system 200 according to one embodiment of the present invention and a method of separation of solids in a mixture housed in the tank of apparatus 200. For example, at least one submersible pump 202 may be submersed into a mixture of at least water, biosolids and/or sand in tank 204 in apparatus or treatment system 200 and designed to pump the mixture from the bottom of tank 204 of treatment system 200, or other depths as required, to remove the mixture from tank 204 of treatment system 200. The removed mixture may be run from submersible pump 202 into a pressurized debris tank 206 via debris hose 208. In one embodiment, pressurized debris tank 206 may be portable. For example, pressurized debris tank 206 may be, but does not have to be, located on a vehicle, such as a truck, as shown in FIG. 2. Pressurized debris tank 206 settles the components of the mixture from tank 204 based on the density and/or buoyancy of the various components in such a mixture, such that the more dense components settle on the bottom of pressurized tank 206, and the more buoyant components do not fall as quickly as the more dense components within pressurized tank 206. The more buoyant components are essentially allowed to move, or striate, to the top of pressurized tank 206 via positive pressure from submersible pump 202 and the action of the settling of the heavier components such as the level of sand as it rises. An example of a system that may be utilized with the present teachings is the system and truck disclosed in U.S. Pat. No. 9,796,003, which is hereby incorporated by reference in its entirety. Still further, the present teachings may be applied utilizing a system that includes a submersible pump, pressurized debris tank, and decanting device only.

For example, the inorganic material such as sand or grit, having a greater density, will settle on the bottom of the pressurized tank, whereas the biosolids and water, having a lower density and higher buoyancy, will not settle on the bottom of the pressurized tank and will instead rise to the top of the pressurized tank, above the sand. Due to the positive pressure inside the pressurized debris tank, the supernatant of the pressurized mixture, comprising the water and/or biosolids, is then transmitted out of the pressurized debris tank, into a return debris hose, or decant hose, 210, and back into tank 204 of system 200. As the supernatant is routed back into tank 204 of system 200, the mixture in tank 204 of system 200 is agitated, causing a slurry formed from all, or some, of the components (i.e., water, biosolids and/or sand) as the various components are mixed together. In one embodiment, this may be necessary in order for the water portion of the mixture in tank 204 to carry the sand and/or grit portion out of tank 204 and into pressurized tank 206 via pump 202 and hose 208. In one example, at least the sand and water need to be mixed together to carry the sand out of tank 204 and into pressurized tank 206 by being carried with the water. The slurry may be partially mixed, fully mixed or separated but removed together. The method of de-sanding may not need a separate water supply and, instead, the water within tank 204 may be utilized to remove the sand and grit therefrom. The method may be accomplished with system 200 and/or tank 204 being online (i.e., operating) or being offline (i.e., not operating). It should be noted that while a tank 206 is illustrated in connection with system 200 any device or item that can hold water and/or one or more solids or slurries can also be used in system 200.

All, or some of, the components are mixed together, may be needed for the water to carry the sand and/or grit out of the treatment system and into pressurized tank 206. In one example, at least the sand and water need to be mixed together to carry the sand out of at least tank 204 and into pressurized tank 206. The slurry may be partially mixed, fully mixed or separated but removed together. The method of de-sanding may not need a separate water supply and, instead, the water within treatment system 200 (e.g., in tank 204) may be utilized to remove the sand and/or grit also located in at least tank 204 or some other liquid/slurry holding device. The method may be accomplished with treatment system 200 and/or tank 204 being online (i.e., operating) or being offline (i.e., not operating).

As way of a non-limiting example, the present teachings may be utilized in cleaning lift stations and pump stations. Lift and pump stations may be used to pump wastewater from a lower to higher elevation, particularly where the elevation of the sewer pipe is not sufficient for gravity flow. Wastewater will collect inside a well which is part of said lift/pump station, once the wastewater reaches a certain level, the pumps are activated to transmit the wastewater from the low elevation of the well, to the higher elevation of another sewer pipe. In such systems inorganic material may accumulate that needs to be removed. The present teachings may be applied to remove such inorganic material from the lift and pump stations.

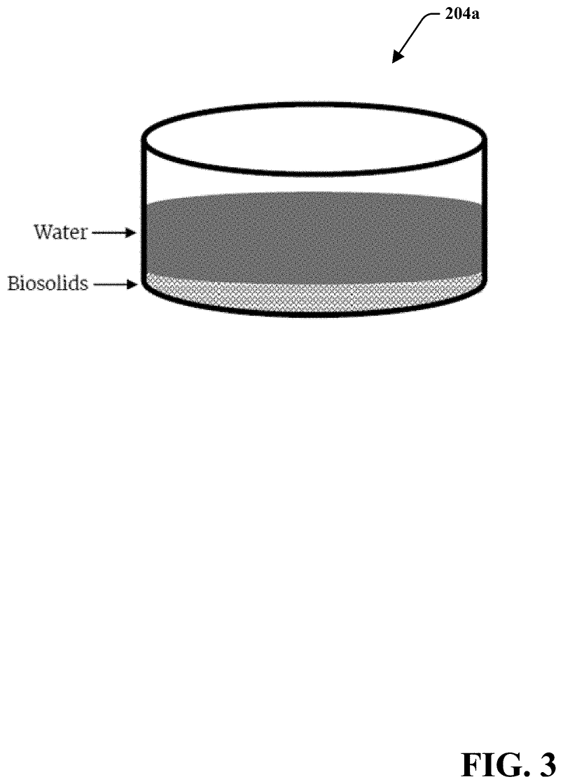

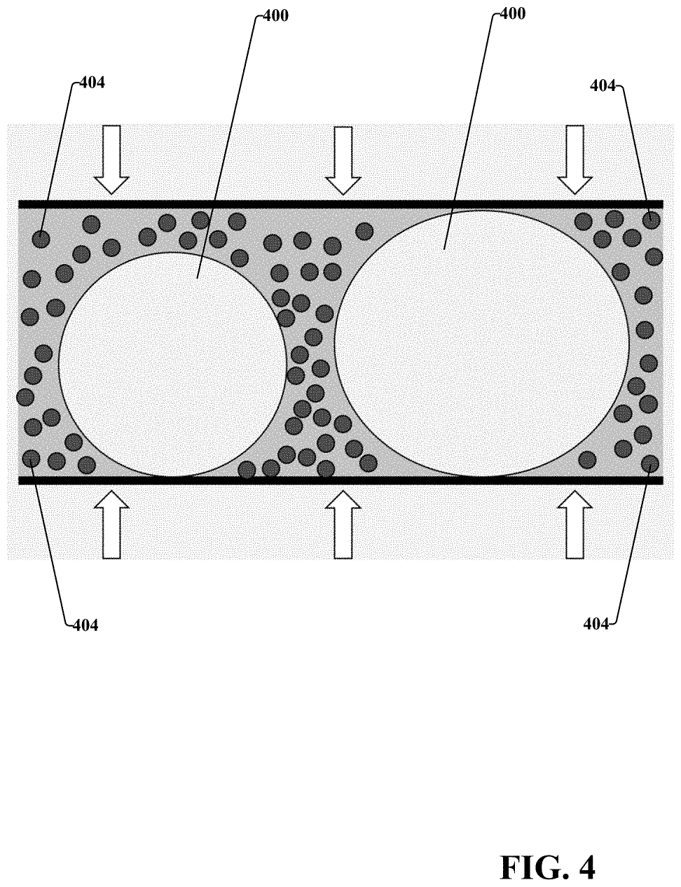

In an embodiment, one process of routing a solid and liquid mixture from a tank, or other liquid/slurry holding device, 204 in treatment system 200 into a submersible pump 202, may be transmitted via a debris hose 208 to a pressurized tank 206 and back into tank, or other liquid/slurry holding device, 204 of treatment system 200 via the positive pressure from submersible pump 202 and a decant hose 210. This process can be repeated until all or the desired amount of the sand or other dense components are removed from the mixture. FIG. 3 depicts the de-sanded mixture or supernatant in a tank 204a of treatment system 200 after the sand, grit and other similarly dense components have been removed. As before, the de-sanded mixture, comprising water and/or biosolids, may be fully mixed, partially mixed, or layered as shown in FIG. 3. In an embodiment, the supernatant including biosolids and water is further separated using a dewatering process, such as a belt filter press, filter, or centrifuge, as a full cleaning process to capture the biosolids. An example of a belt filter press is shown in FIG. 4. In this embodiment of the belt filter press, the biosolids are being separated from the liquid within the treatment system. Specifically, FIG. 4 displays how sand or other inorganic material 400 may create a bridge for the biosolids 404 to pass through a belt filter press without being dewatered.

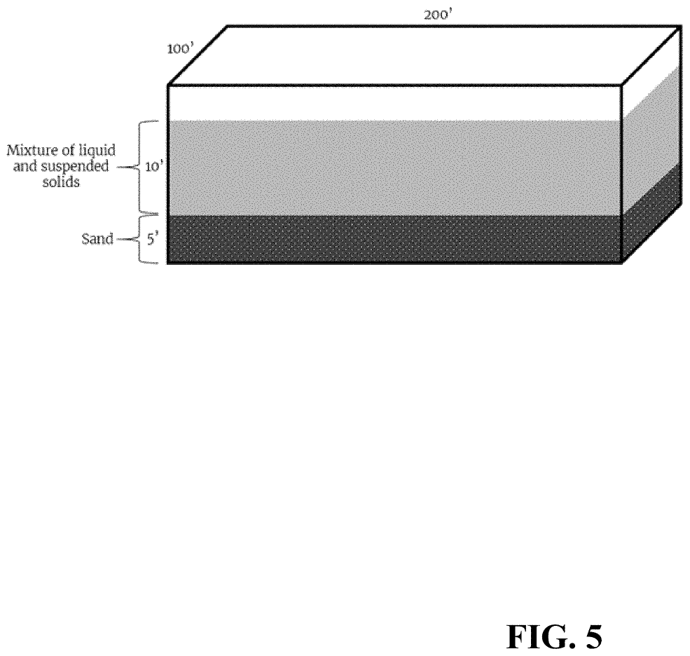

In an embodiment, computations may be performed to determine the estimated amount of sand, grit or other components of the same or similar density to be removed from a treatment system. Once the volume of sand, grit or other components to be removed has been determined, a slurry concentration may be estimated to determine the rate of sand, grit or other components removed. Thereafter, the amount of liquid required to move the material may be determined and, finally, the amount of times the solid and liquid mixture of the treatment system will need to be cycled through the de-sanding process to remove the sand, grit or other components may be better quantified. As a non-limiting example, the steps of such a calculation may comprise: (1) estimate quantity of sand, grit or other component to be removed; (2) apply pumping concentration; (3) estimate volume of water to transport inorganic material (sand, grit or other components) via slurry to pressurized container; (4) compute volume of liquid in a tank or other holding system of treatment system; and (5) estimate amount of time to recirculate liquid in tank to remove inorganic material (sand, grit or other components). An exemplary embodiment of the present application is as follows. It should be understood, however, that this calculation is merely exemplary and is not intended to be limiting. FIG. 5 depicts the wastewater treatment system utilized in this exemplary embodiment.

### Exemplary Embodiment

First, compute volume of contents inside the wastewater treatment system: (a) in a rectangle wastewater treatment system multiply the length by width by the depth of the contents inside the wastewater treatment system; and (b) example: volume of contents: 100 feet by 200 feet by 15 feet=300,000 cubic feet.

Second, compute volume of inorganic material within the contents of the wastewater treatment system by: (a) in a rectangle wastewater treatment system multiply the length by width by the depth of the inorganic material inside the wastewater treatment system; and (b) example: volume of inorganic material: 100 feet by 200 fee by 5 feet=100,000 cubic feet.

Third, compute the volume of liquid required to remove the inorganic material from the wastewater treatment system by: (a) divide the volume of inorganic material inside the wastewater treatment system by the percentage of solids in a liquid that the submersible pump is capable of removing (where for example a submersible pump will be able to pump a liquid that contains, for example, 10 percent to 20 percent total suspended solids; and (b) example: volume of liquid required to remove the inorganic material from the wastewater treatment system: 100,000 cubic feet divided by 0.10=1,000,000 cubic feet.

Fourth, determine the number of times that the liquid contents of the wastewater treatment system will need to cycle through the pressurized debris tank in order to remove the inorganic material from the wastewater treatment system by: (a) divide the volume of liquid required to remove the inorganic material from the wastewater treatment system by the difference between the volume of contents inside the wastewater treatment system and the volume of inorganic material within the contents of the wastewater treatment system; and (b) example: number of times that the contents of the wastewater treatment system will need to cycle through the pressurized debris tank in order to remove the inorganic material from the wastewater treatment system: 1,000,000 cubic feet divided by (300,000 cubic feet−100,000 cubic feet)=5 times.

Fifth, determine the amount of time it will take to remove the inorganic material from the wastewater treatment system by: (a) convert the volume of liquid required to remove the inorganic material from the wastewater treatment system from cubic feet to gallons. One cubic foot is approximately 7.48 US liquid gallons. Divide the gallons of liquid required to remove the inorganic material from the wastewater treatment system by the pumping capacity of the submersible pump in gallons per minute (GPM); and (b) example: the number of hours it will take to remove the inorganic material from the wastewater treatment system: (i) 1,000,000 cubic feet time 7.48=7,480,000 gallons; and (ii) 7,480,000 gallons divided by 2500 GPM=2,992 minutes or 49.87 hours.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

1. A system for de-sanding a treatment system comprising:
at least one liquid, or slurry, holding device, wherein the at least one liquid, or slurry, holding device contains therein at least one mixture of water with at least one type of solid sand material and/or at least one type of biosolids;
at least one submersible pump, wherein the submersible pump is able to pump the mixture contained in the at least one liquid, or slurry, holding device;
at least one debris tank, operatively connected to the at least one submersible pump and the at least one liquid, or slurry, holding device via at least one hose; and
at least one decant hose that is operatively connected to both the at least one debris tank and the at least one at least one liquid, or slurry, holding device, wherein the at least one decant hose is designed to return a portion of the material from the at least one debris tank to the at least one liquid, or slurry, holding device,
wherein the system removes at least one of the sand or biosolids located within the mixture of the water with at least one type of solid sand material and/or at least one type of biosolids.

2. The system of claim 1, wherein the system removes the sand from the mixture of water and sand, or the sand from the mixture of water, sand and biosolids, in the at least one liquid, or slurry, holding device.

3. The system of claim 1, wherein the at least one debris tank is a pressurized debris tank.

4. The system of claim 1, wherein the system removes at least one type of biosolids from the mixture of water and biosolids, or at least one type of biosolids from the mixture of water, sand and biosolids, in the at least one liquid, or slurry, holding device.

5. The system of claim 1, wherein the system removes at least one type of biosolids and the sand from the mixture of water, sand and biosolids in the at least one liquid, or slurry, holding device.

6. A method for de-sanding a treatment system comprising:
supplying at least one liquid, or slurry, holding device, wherein the at least one liquid, or slurry, holding device contains therein at least one mixture of water with at least one type of solid sand material and/or at least one type of biosolids;
supplying at least one submersible pump, wherein the submersible pump is able to pump the mixture contained in the at least one liquid, or slurry, holding device;
supplying at least one debris tank, operatively connected to the at least one submersible pump and the at least one liquid, or slurry, holding device via at least one hose; and
supplying at least one decant hose that is operatively connected to both the at least one debris tank and the at least one at least one liquid, or slurry, holding device,
wherein the at least one decant hose returns a portion of the material from the at least one debris tank to the at least one liquid, or slurry, holding device, and
wherein the system removes at least one of the sand or biosolids located within the mixture of the water with at least one type of solid sand material and/or at least one type of biosolids.

7. The method of claim 6, wherein the method removes the sand from the mixture of water and sand, or the sand from the mixture of water, sand and biosolids, in the at least one liquid, or slurry, holding device.

8. The method of claim 6, wherein the at least one debris tank is a pressurized debris tank.

9. The method of claim 6, wherein the method removes at least one type of biosolids from the mixture of water and biosolids, or at least one type of biosolids from the mixture of water, sand and biosolids, in the at least one liquid, or slurry, holding device.

10. The method of claim 6, wherein the method removes at least one type of biosolids and the sand from the mixture of water, sand and biosolids in the at least one liquid, or slurry, holding device.

11. A method for de-sanding a treatment system comprising:
supplying at least one liquid, or slurry, holding device, wherein the at least one liquid, or slurry, holding device contains therein at least one mixture of water with at least one type of solid sand material and at least one type of biosolids;
supplying at least one submersible pump, wherein the submersible pump is able to pump the mixture contained in the at least one liquid, or slurry, holding device;
supplying at least one debris tank, operatively connected to the at least one submersible pump and the at least one liquid, or slurry, holding device via at least one hose; and
supplying at least one decant hose that is operatively connected to both the at least one debris tank and the at least one at least one liquid, or slurry, holding device,
wherein the at least one decant hose returns a portion of the at least one type of biosolids from the at least one debris tank to the at least one liquid, or slurry, holding device, and
wherein the system removes at least one of the sand located within the mixture of the water with at least one type of solid sand material and the at least one type of biosolids.

12. The method of claim 11, wherein the method removes the sand from the mixture of water, sand and biosolids in the at least one liquid, or slurry, holding device.

13. The method of claim 11, wherein the at least one debris tank is a pressurized debris tank.
